(19) United States
(12) Patent Application Publication
(10) Pub. No.: US 2018/0028391 A1
(43) Pub. Date: Feb. 1, 2018

(54) Multifunctional Cane

(71) Applicant: Bradley G. Apple, Denver, CO (US)

(72) Inventor: Bradley G. Apple, Denver, CO (US)

(21) Appl. No.: 15/666,407

(22) Filed: Aug. 1, 2017

Related U.S. Application Data
(60) Provisional application No. 62/369,230, filed on Aug. 1, 2016.

(51) Int. Cl. A61H 3/00; A45B 3/04; A45B 1/00

(52) U.S. Cl. CPC A61H 3/00; A45B 1/00; A45B 3/04

(57) ABSTRACT

A multifunction cane is an apparatus that doubles a walking aid and a headrest. If the apparatus is oriented in one direction, then the apparatus can be used as a walking aid. If the apparatus is oriented in the opposite direction, then the apparatus can be used as headrest. The apparatus includes a handle, a length-adjustable structural shaft, a rigid base, an interchangeable padding, and a grasping strap. The handle and the grasping strap allow the user to firmly grasp the apparatus. The length-adjustable structural shaft is the base structure for the apparatus and can be shortened or lengthened in order to accommodate the user's height preferences. The interchangeable padding is used to brace the ground while the apparatus is being used as a walking aid. The interchangeable padding is used to provide a cushion for the user's head while the apparatus is being used as a headrest.

The current application claims a priority to the U.S. Provisional Patent application Ser. No. 62/369,230 filed on Aug. 1, 2017.

### FIELD OF THE INVENTION

The present invention generally relates to a walking cane that can also be used as a headrest. More specifically, the present invention can be used as a walking cane while oriented in one direction and can be used a headrest while oriented in the opposite direction.

### BACKGROUND OF THE INVENTION

Traditionally, a walking cane is a simple shaft that allows a user to transfer some of their weight load away from their legs. A walking cane can be configured with a variety of features, such as a handle, in order improve its functionality as a walking aid, but the simple structure of the walking cane does not provide any other functionalities for the user.

Therefore, an objective of the present invention is to provide a multifunctional cane with a variety of components that allows a user to perform different tasks with the present invention. The configuration for the variety of components enable the present invention to be used in a variety of ways, such as a headrest, a back scratcher, an exercise device, an accessory holder, an extendable grasper, and an illumination device.

### BRIEF DESCRIPTION OF THE DRAWINGS

FIG. 1 is a perspective view of the present invention.

FIG. 2 is an alternative view of the present invention.

FIG. 3 is a side-view of the present invention with the grasping strap omitted.

FIG. 4 is a sectional-view of the present invention.

FIG. 5 is a perspective view of the present invention in an extended configuration.

### DETAILED DESCRIPTION OF THE INVENTION

All illustrations of the drawings are for the purpose of describing selected versions of the present invention and are not intended to limit the scope of the present invention.

The present invention is a multifunctional cane that is configured to execute a variety of functions. One primary function of the present invention is to provide a walking aid to a user when the present invention is oriented in one direction. Another primary function of the present invention is to act as a headrest for the user when the present invention is oriented in the opposite direction. The present invention comprises a handle 1, a length-adjustable structural shaft 4, a rigid base 12, an interchangeable padding 13, and a grasping strap 15. The handle 1 allows the user to easily and readily grasp the present invention. The length-adjustable structural shaft 4 is used to support the user's weight as the user leans on the present invention. The length-adjustable structural shaft 4 can be lengthened or shorten in order to accommodate the user's height and the user's comfort. The rigid base 12 is used to maintain the shape of the interchangeable padding 13, while the interchangeable padding 13 either braces the ground or cushions the user's head. The grasping strap 15 allows the user to further secure the present invention to their hand.

The general configuration of the aforementioned components allows the present invention to efficiently and effectively double as a walking aid and a headrest. In order to disclose the proper arrangement for the aforementioned components, the length-adjustable structural shaft 4 needs to comprise a first shaft end 5 and a second shaft end 6. The handle 1 is laterally connected to the length-adjustable structural shaft 4, which allows the user to grasp the handle 1 in a generally perpendicular direction to the length-adjustable structural shaft 4. This arrangement also allows the user to directly transfer the necessary relief load through the present invention and into the ground. The handle 1 is positioned adjacent to the first shaft end 5 so that the user's grasp of the present invention is sufficiently offset from the ground. Moreover, the rigid base 12 is connected adjacent to the second shaft end 6, which allows the present invention to function as a walking aid while oriented in one direction and allows the present invention to function as a headrest while oriented in the opposite direction. The interchangeable padding 13 is also attached adjacent to the rigid base 12, opposite to the second shaft end 6, so that the interchangeable padding 13 can be detached from the rigid base 12 and replaced with another interchangeable padding. Each different kind of interchangeable padding is each configured to properly support different areas of the user's body. For example, one interchangeable padding could be configured to support a user's chin, while another interchangeable padding could be configured to support the user's armpit. Finally, the grasping strap 15 is terminally attached to the length-adjustable structural shaft 4 because the user can only grasp one end of the length-adjustable structural shaft 4 at a time. This allows the grasping strap 15 to be on the end of the length-adjustable structural shaft 4 that is being held by the user's hand.

Thus, the general configuration of the aforementioned components allows the present invention to execute two primary functions. One primary function is to use the present invention as a walking aid, which orients the handle 1 in the upward direction and orients the interchangeable padding 13 in the downward direction. This primary function allows the user to grasp the handle 1 with their hand and to press the interchangeable padding 13 against the ground. In addition, the other primary function is to use the present invention as a headrest, which orients the interchangeable padding 13 in the upward direction and orients the handle 1 in the downward direction. This primary function allows the user to rest their head against the interchangeable padding 13 and keep their neck in the proper posture, while pressing the handle 1 against the ground.

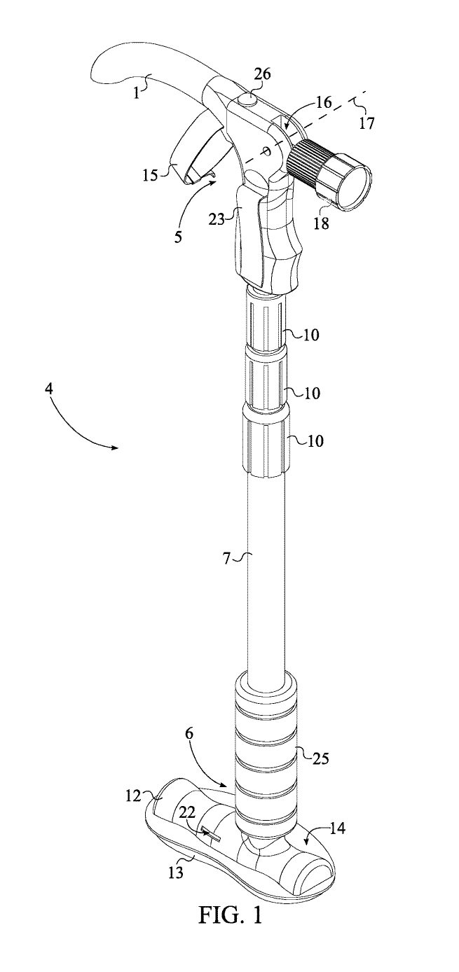

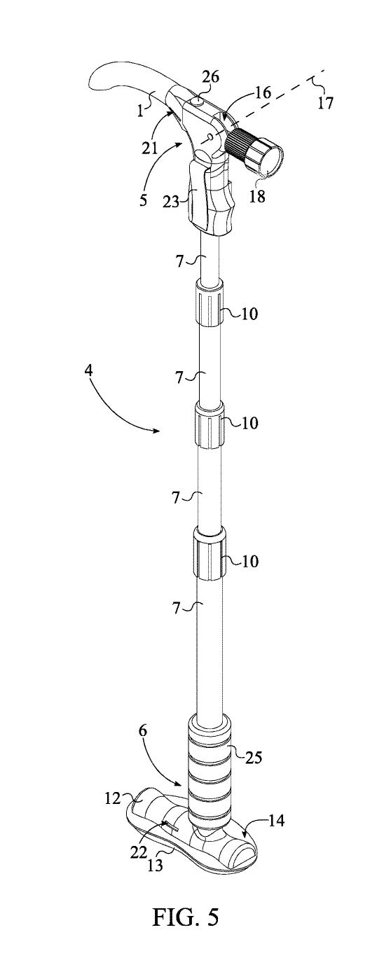

The user needs to be able to readily lengthen or shorten the length-adjustable structural shaft 4 as seen in FIG. 1 and FIG. 5. Thus, the length-adjustable structural shaft 4 may comprise a plurality of nested tubes 7, a plurality of grips 10, and a compression spring 11. Each of the plurality of nested tubes 7 has a smaller diameter than its preceding tube from the plurality of nested tubes 7, which allows the plurality of nested tubes 7 to be telescopically engaged amongst each other. Consequently, the plurality of nested tubes 7 is able to slide amongst each other in order to readily lengthen or shorten the length-adjustable structural shaft 4. Moreover, the plurality of grips 10 allows the user to select and slide any of the plurality of nested tubes 7. Therefore, each of the plurality of grips 10 is laterally mounted around a corresponding tube from the plurality of nested tubes 7 so that the user is able to firmly grasp any selected tube from the plurality of nested tubes 7 and is able to slide the selected tube in either direction along the length-adjustable structural shaft 4.

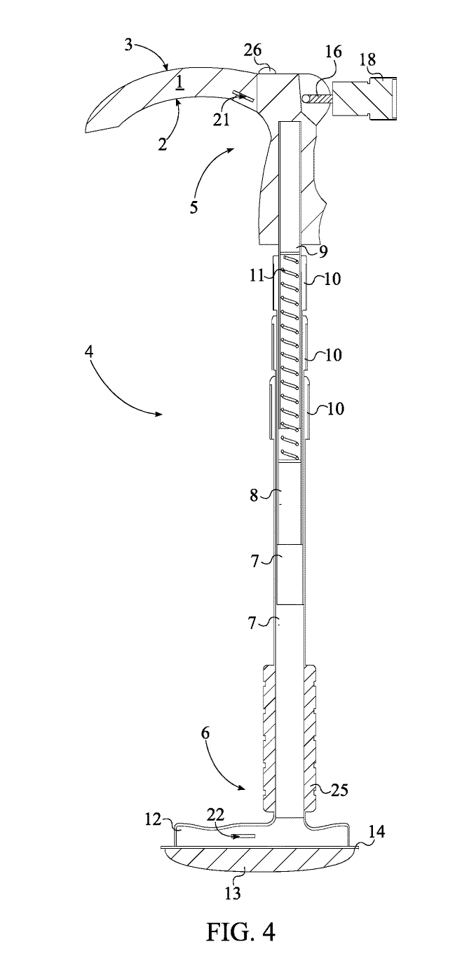

Referring to FIG. 4, in addition, the compression spring 11 allows the length-adjustable structural shaft 4 to elastically compress to a length shorter than its shortest equilibrium length. The user may want to compress the length-adjustable structural shaft 4 as a means to perform physical exercises on a particular body part. In order to elastically compress the length-adjustable structural shaft 4 to a length shorter than its shortest equilibrium length, the compression spring 11 is to be positioned within the plurality of nested tubes 7 and is to pressed in between a specific tube 8 and a subsequent tube 9. The specific tube 8 and the subsequent tube 9 are any adjacent pair of tubes from the plurality of nested tubes 7. Consequently, the remaining tubes from the plurality of nested tubes 7 can be positioned within each other in order to achieve the shortest equilibrium length for the length-adjustable structural shaft 4, while the user needs to push the specific tube 8 into the subsequent tube 9 in order to further reduce the length of the length-adjustable structural shaft 4. As an example, the user could perform leg exercises by compressing the compression spring 11 during a long bus or airplane ride in order to improve blood flow while sitting. The present invention can be used to perform a variety of physical exercises that include, but are not limited to, arm exercises, chest exercises, and stomach exercises.

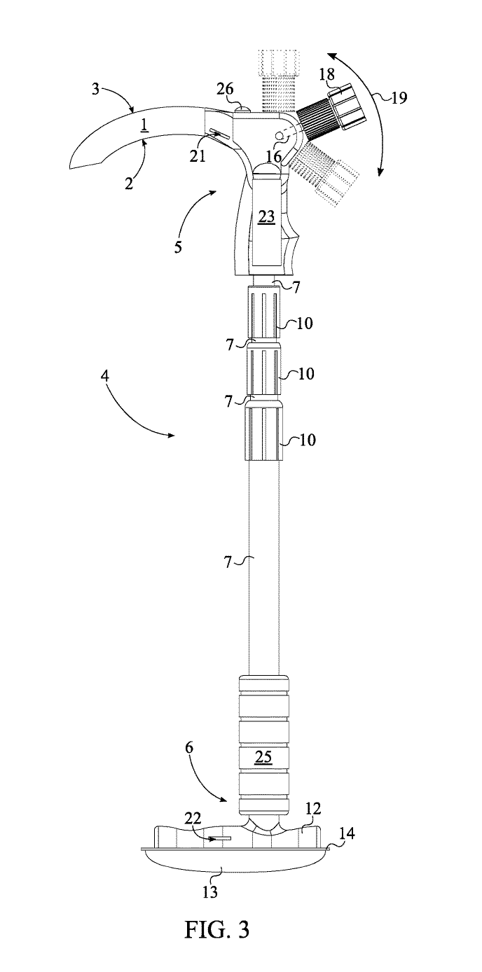

Another function of the present invention is to readily provide the user with illumination. Thus, the present invention may further comprise a pivotable fixture 16 and a flashlight 18. The pivotable fixture 16 is used to mount the flashlight 18 onto the present invention and is used to guide the movement of the flashlight 18. The pivotable fixture 16 is hingedly mounted to the first shaft end 5, and, more specifically, a rotation axis 17 of the pivotable fixture 16 is oriented perpendicular to the length-adjustable structural shaft 4. This arrangement allows the pivotable fixture 16 to rotate about the first shaft end 5. The flashlight 18 allows the present invention to provide the necessary illumination for the user and is mounted onto the pivotable fixture 16 so that the flashlight 18 can rotate with the pivotable fixture 16. In addition, the rotational path 19 of the flashlight 18 is preferably coplanar with the handle 1, which allows the flashlight 18 to be oriented collinear with the length-adjustable structural shaft 4, allows the flashlight 18 to the oriented perpendicular to the length-adjustable structural shaft 4, or allows the flashlight 18 to be anywhere in between those two positions as seen in FIG. 3. Moreover, the present invention may further comprise a clamping mechanism 20 that is operatively integrated in between the first shaft end 5 and the pivotable fixture 16. The clamping mechanism 20 is used to lock in place the pivotable fixture 16, once the user selects a desired position for the flashlight 18. In one embodiment, the clamping mechanism 20 is a knob that is threadably engaged with the first shaft end 5, coincident with the rotation axis 17 of the pivotable fixture 16. Rotating the knob clockwise or counter-clockwise will lock or unlocks, respectively, the pivotable fixture 16 relative to the first shaft end 5.

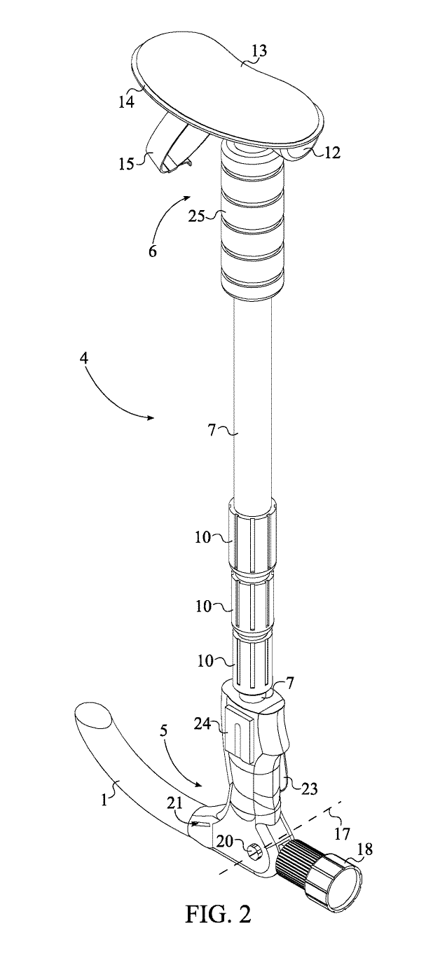

Referring to FIG. 1 and FIG. 2, the present invention allows the grasping strap 15 to be selectively tethered to either end of the length-adjustable structural shaft 4. Thus, the present invention may further comprise a first strap-receiving eyelet 21 and a second strap-receiving eyelet 22, which are both used as attachment points for the grasping strap 15. The first strap-receiving eyelet 21 is integrated into the handle 1 and allows the user to selectively loop the grasping strap 15 through the first strap-receiving eyelet 21. In addition, the second strap-receiving eyelet 22 is integrated into the handle 1 and allows the user to selectively loop the grasping strap 15 through the first strap-receiving eyelet 21.

Referring to FIG. 3 and FIG. 4, another function of the present invention allows the user to hook an out-of-reach object with the handle 1 and to pull the out-of-reach object towards the user. Thus, the handle 1 may comprise a concave lengthwise portion 2 and a convex lengthwise portion 3, both of which shape the handle 1 to have an overall curved profile. The concave lengthwise portion 2 is oriented towards the rigid base 12, and the convex lengthwise portion 3 is oriented away from the rigid base 12 so that the overall curved profile of the handle 1 can be easily used to hook and pull an out-of-reach object towards the user. In addition, the over curved profile of handle 1 allows the user to reach and scratch their back with the present invention.

Referring to FIG. 2, the interchangeable padding 13 is designed to bear and stabilize the user's weight as the present invention is being used as a walking aid. Thus, the interchangeable padding 13 comprises a wide bracing face 14, which is used to receive and to distribute the load felt from the handle 1, through the length-adjustable structural shaft 4, and to the rigid base 12. The rigid base 12 is attached onto the wide bracing face 14 and is centrally positioned across the wide bracing face 14.

Consequently, the perimeter of the wide bracing face 14 encompasses the entire contact point of the rigid base 12, which allows the rigid base 12 to evenly distributed the load throughout the interchangeable padding 13. Moreover, the interchangeable padding 13 is preferable made of a neoprene material.

The present invention may also include a variety of miscellaneous features, each of which provide the present invention with a unique additional functionality for the user. One such miscellaneous feature is a belt clip 23 that allows a user to readily attach the present invention to their waist belt. The belt clip 23 is laterally mounted to the length-adjustable structural shaft 4 and is positioned adjacent to the first shaft end 5, which allows the present invention to comfortably lie against the user's leg while the belt clip 23 is attached onto the user's waist belt. Another such miscellaneous feature is an accessory mount 24, which can be used to mount a tablet personal computer, a mobile phone, a book, or any other viewable objects or devices. The accessory mount 24 is laterally mounted to the length-adjustable structural shaft 4 and is positioned adjacent to the first shaft end 5, which allows the present invention to rest the interchangeable padding 13 against the ground, while the user is able to comfortably view the accessory mount 24 at a comfortable distance offset from the ground. Another such miscellaneous feature is the handgrip 25, which allows the user to grasp the present invention around the length-adjustable structural shaft 4 while the interchangeable padding 13 is oriented upwards. Consequently, the handgrip 25 is laterally connected around the length-adjustable structural shaft 4 and is positioned adjacent to the second shaft end 6. The handgrip 25 is preferably made of a neoprene material. Another miscellaneous feature is a magnetic compass 26, which provide the user with geospatial guidance, while the present invention is being used a walking aid. The magnetic compass 26 is integrated into the first shaft end 5 so that the user can simply look down and view the magnetic compass 26 while simultaneously grasping the handle 1. The arrangement of the magnetic compass 26 and the handle 1 prevents the user's hand from visually obstructing the magnetic compass 26.

Although the invention has been explained in relation to its preferred embodiment, it is to be understood that many other possible modifications and variations can be made without departing from the spirit and scope of the invention as hereinafter claimed.

What is claimed is:

1. A multifunctional cane comprises:
a handle;
a length-adjustable structural shaft;
a rigid base;
an interchangeable padding;
a grasping strap;
the length-adjustable structural shaft comprises a first shaft end and a second shaft end;
the handle being laterally connected to length-adjustable structural shaft;
the handle being positioned adjacent to the first shaft end;
the rigid base being connected adjacent to the second shaft end;
the interchangeable padding being attached adjacent to the rigid base, opposite to the second shaft end; and
the grasping strap being terminally attached to the length-adjustable structural shaft.

2. The multifunctional cane as claimed in claim 1 comprises:
the length-adjustable structural shaft comprises a plurality of nested tubes; and
the plurality of nested tubes being telescopically engaged amongst each other.

3. The multifunctional cane as claimed in claim 2 comprises:
the length-adjustable structural shaft further comprises a plurality of grips; and
each of the plurality of grips being laterally connected around a corresponding tube from the plurality of nested tubes.

4. The multifunctional cane as claimed in claim 2 comprises:
the length-adjustable structural shaft further comprises a compression spring;
the plurality of nested tubes comprises a specific tube and an subsequent tube;
the compression spring being positioned within the plurality of nested tubes; and
the compression spring being pressed in between the specific tube and the subsequent tube.

5. The multifunctional cane as claimed in claim 1 comprises:
a pivotable fixture;
a flashlight;
the pivotable fixture being hingedly mounted to the first shaft end;
a rotation axis of the pivotable fixture being oriented perpendicular to the length-adjustable structural shaft; and
the flashlight being mounted onto the pivotable fixture.

6. The multifunctional cane as claimed in claim 5 comprises:
a rotational path of the flashlight being coplanar with the handle.

7. The multifunctional cane as claimed in claim 5 comprises:
a clamping mechanism; and
the clamping mechanism being operatively integrated in between the first shaft end and the pivotable fixture, wherein the clamping mechanism is used to lock in place the pivotable fixture.

8. The multifunctional cane as claimed in claim 1 comprises:
a first strap-receiving eyelet;
the first strap-receiving eyelet being integrated into the handle; and
the grasping strap being looped through the first strap-receiving eyelet.

9. The multifunctional cane as claimed in claim 1 comprises:
a second strap-receiving eyelet;
the second strap-receiving eyelet being integrated into the rigid base; and
the grasping strap being looped through the second strap-receiving eyelet.

10. The multifunctional cane as claimed in claim 1 comprises:
the handle comprises a concave lengthwise portion and a convex lengthwise portion;
the concave lengthwise portion being oriented towards the rigid base; and
the convex lengthwise portion being oriented away from the rigid base.

11. The multifunctional cane as claimed in claim 1 comprises:
the interchangeable padding comprises a wide bracing face;
the rigid base being attached onto the wide bracing face; and
the rigid base being centrally positioned across the wide bracing face.

12. The multifunctional cane as claimed in claim 1 comprises:
a belt clip;
the belt clip being laterally mounted to the length-adjustable structural shaft; and
the belt clip being positioned adjacent to the first shaft end.

13. The multifunctional cane as claimed in claim 1 comprises:
an accessory mount;
the accessory mount being laterally mounted to the length-adjustable structural shaft; and
the accessory mount being positioned adjacent to the first shaft end.

14. The multifunctional cane as claimed in claim 1 comprises:
a hand grip;
the hand grip being laterally connected around the length-adjustable structural shaft; and
the hand grip being positioned adjacent to the second shaft end.

15. The multifunctional cane as claimed in claim 1 comprises:
a magnetic compass; and
the magnetic compass being integrated into the first shaft end.

16. A multifunctional cane comprises:
a handle;
a length-adjustable structural shaft;
a rigid base;
an interchangeable padding;
a grasping strap;
the length-adjustable structural shaft comprises a first shaft end, a second shaft end, a plurality of nested tubes, a plurality of grips, and a compression spring;
the plurality of nested tubes comprises a specific tube and an subsequent tube;
the handle being laterally connected to length-adjustable structural shaft;
the handle being positioned adjacent to the first shaft end;
the rigid base being connected adjacent to the second shaft end;
the interchangeable padding being attached adjacent to the rigid base, opposite to the second shaft end;
the grasping strap being terminally attached to the length-adjustable structural shaft;
the plurality of nested tubes being telescopically engaged amongst each other;
each of the plurality of grips being laterally connected around a corresponding tube from the plurality of nested tubes;
the compression spring being positioned within the plurality of nested tubes; and
the compression spring being pressed in between a specific tube and the subsequent tube.

17. The multifunctional cane as claimed in claim 16 comprises:
a pivotable fixture;
a flashlight;
a clamping mechanism;
the interchangeable padding comprises a wide bracing face;
the pivotable fixture being hingedly mounted to the first shaft end;
a rotation axis of the pivotable fixture being oriented perpendicular to the length-adjustable structural shaft;
the flashlight being mounted onto the pivotable fixture;
a rotational path of the flashlight being coplanar with the handle;
the clamping mechanism being operatively integrated in between the first shaft end and the pivotable fixture, wherein the clamping mechanism is used to lock in place the pivotable fixture;
the rigid base being attached onto the wide bracing face; and
the rigid base being centrally positioned across the wide bracing face.

18. The multifunctional cane as claimed in claim 16 comprises:
a first strap-receiving eyelet;
a second strap-receiving eyelet;
the first strap-receiving eyelet being integrated into the handle;
the grasping strap being looped through the first strap-receiving eyelet;
the second strap-receiving eyelet being integrated into the rigid base; and
the grasping strap being looped through the second strap-receiving eyelet.

19. The multifunctional cane as claimed in claim 16 comprises:
a hand grip;
the handle comprises a concave lengthwise portion and a convex lengthwise portion;
the concave lengthwise portion being oriented towards the rigid base;
the convex lengthwise portion being oriented away from the rigid base;
the hand grip being laterally connected around the length-adjustable structural shaft; and
the hand grip being positioned adjacent to the second shaft end.

20. The multifunctional cane as claimed in claim 16 comprises:
a belt clip;
an accessory mount;
a magnetic compass;
the belt clip being laterally mounted to the length-adjustable structural shaft;
the belt clip being positioned adjacent to the first shaft end;
the accessory mount being laterally mounted to the length-adjustable structural shaft;
the accessory mount being positioned adjacent to the first shaft end; and
the magnetic compass being integrated into the first shaft end.
